(19) United States
(12) Patent Application Publication
(10) Pub. No.: US 2026/0082160 A1
(43) Pub. Date: Mar. 19, 2026

(54) BIOMIMETIC MICROPHONE

(71) Applicant: STICHTING RADBOUD UNIVERSITEIT, Nijmegen (NL)

(72) Inventors: Martijn AGTERBERG, Nijmegen (NL); Patrick Wilhelmus Andreas WIJNINGS, Nijmegen (NL)

(73) Assignee: STICHTING RADBOUD UNIVERSITEIT, Nijmegen (NL)

(21) Appl. No.: 19/146,141

(22) PCT Filed: Dec. 13, 2023
(86) PCT No.: PCT/NL2023/050655

§ 371 Date: Jul. 7, 2025

(30) Foreign Application Priority Data
Jan. 5, 2023 (NL) 2033911

(51) Int. Cl. H04R 25/00

(52) U.S. Cl. CPC H04R 25/405; H04R 2225/67

(57) ABSTRACT

The invention relates to a biomimetic microphone, a product comprising at least one biomimetic microphone, such as a hearing aid, wherein the hearing implant may comprise a cochlear implant, or a vibrating implant, or both, a method of operating a hearing implant, and a hearing implant computer program comprising instructions for operating the hearing implant.

### FIELD OF THE INVENTION

The invention relates to a biomimetic microphone, a product comprising at least one biomimetic microphone, such as a hearing aid, wherein the hearing implant may comprise a cochlear implant, or a vibrating implant, or both, a method of operating a hearing implant, and a hearing implant computer program comprising instructions for operating the hearing implant.

### BACKGROUND OF THE INVENTION

A microphone is an electrical device. It typically comprises a transducer, that is, an element or elements that are configured to convert sound into an electrical signal. Microphones may be used in many applications and products, of which a hearing aid is considered to be an example in particular considered. They may also be used in computers for recording voice, speech recognition, VoIP, and for other purposes such as ultrasonic sensors or knock sensors. Microphones may employ different elements in order to convert the air pressure variations of a sound wave to an electrical signal. Examples are a dynamic microphone, a condenser microphone, and a contact microphone. Microphones typically need to be connected to or comprise a preamplifier before the signal can be recorded or reproduced.

An ear is also capable of receiving sound and converting sound to a signal that may be perceived. The ear enables hearing and, in mammals, balance. In mammals the ear may be described as having three parts, namely the outer ear, the middle ear, and the inner ear. The present invention is partly focused on the inner ear, in particular on the cochlea and hair cells in the cochlea. The inner ear is located in a bony labyrinth, and contains structures which are considered to be essential to several senses: the semi-circular canals, which enable balance and eye tracking when moving; the utricle and saccule, which enable balance when stationary; and the cochlea, which enables hearing. As the present invention primarily relates to hearing, the cochlea is in that respect of most interest.

The cochlea (Greek for “snail”) is a tonotopically organised spiral-shaped, hollow, conical chamber of bone, in which sound waves propagate. The cochlea includes three scalae or chambers, namely a vestibular, which lies superior to the cochlear duct and abuts the oval window, a tympanic duct, which lies inferior to the cochlear duct and terminates at the round window, and a cochlear duct that the stereocilia of the hair cells project into. Further the cochlea includes the helicotrema, Reissner's membrane, the osseous spiral lamina, the basilar membrane, Corti's organ, the sensory epithelium, a cellular layer on the basilar membrane, in which sensory hair cells are located, and the spiral ligament. The tonotopic organization of the hair cells means that each position on the basilar membrane represents a certain frequency. Lower frequencies have waves that propagate along the complete cochlea, whereas higher frequencies propagate less far. In humans frequencies from 100 Hz up to 20 kHz are represented. The tonotopic organization that has its foundation in the cochlea is maintained in the entire auditory system. In the brainstem up to the auditory cortex a specific location in the brain represents a certain frequency. So, in contrast to the visual system the auditory system is not organized in a spatial manner. Spatial information is processed by integration of signals originating from the two cochleae. The cochlea receives sound in the form of sound vibrations, which cause the stereocilia to move. The stereocilia then convert these vibrations into nerve impulses which are taken up to the brain to be interpreted by the brain, that is, when sound is perceived. Two fluid-filled outer spaces are present as well. Air or fluid in general is not well compressible, and therefore the fluid volume needs to exit somewhere.

In the cochlea, hair cells are arranged in four rows in the organ of Corti along the entire length of the cochlear coil. The inner hair cells provide the main neural output of the cochlea towards to the auditory nerve. The outer hair cells mainly receive neural input from the brain, which influences their motility as part of the cochlea's mechanical pre-amplifier. The input to the outer hair cells is from the olivary body via the medial olivocochlear bundle.

The cochlear duct has a complex shape. The cochlea is filled with a watery liquid, which moves in response to the vibrations coming from the middle ear via the oval window. As the fluid moves, thousands of hair cells sense the motion, and convert that motion to electrical signals that are communicated via neurotransmitters to many thousands of nerve cells. These primary auditory neurons transform the signals into electrochemical impulses known as action potentials, which travel along the auditory nerve to structures in the brainstem for further processing. When signals are receiving the auditory cortex subjects may form a conscious percept of sound (location). The hair cells are adapted to receive limited sound frequencies by their location in the cochlea (tonotopic organization), and due to varying stiffness of the cells. Ears need to be protected from noise, such as loud noise, continued noise, etc. Noise may cause hair cells to die, eventually. This is a common cause of partial hearing loss.

The present invention is amongst others in the field of a hearing implant, and in particular vibrating hearing implants like bone-conduction implants and middle ear implants, but also cochlear implants. Vibrating hearing implants are provided to persons with a conductive hearing loss. A cochlear implant is typically a surgically implanted neuroprosthesis that provides a person with sensorineural hearing loss a modified sense of sound. The implant bypasses the normal acoustic hearing process. It provides electric signals which directly stimulate the auditory nerve. A person with a cochlear implant may learn to interpret those signals as sound and speech, especially when hearing ability was present, and was lost relatively shortly ago. Otherwise, intensive auditory training may be required, which is far more cumbersome.

The cochlear implant typically has two main components. An outside component, which is generally worn on the skin of the head and coupled with a magnet. The outside component typically comprises a sound processor, comprising microphones, electronics, for signal processing, and typically digital signal processing, a battery, and a transmitter, such as a coil, that transmits a signal to the inside component across the skin. The inside component, the actual implant, likewise has a receiver, such as a coil, to receive signals, and often further electronics, and an array of electrodes which is placed into the cochlea, which stimulates the cochlear nerve. Surgical risks of implantation are considered minimal.

From the early days of implants speech perception via an implant has steadily improved. Many users of modern implants obtain reasonable to good hearing and speech perception skills after implantation. One of the challenges that remain with these implants is that hearing and speech understanding skills after implantation show a wide range of variation across individual implant users and speech understanding in noisy conditions is in general poor. Factors such as duration and cause of hearing loss, how the implant is situated in the cochlea, the overall health of the cochlear nerve, but also individual capabilities of relearning are considered to contribute to this variation, yet no certain predictive factors are known. A further issue is that typically hearing implants are provided to both ears/cochleae. These two implants provide unreliable information in terms of interaural time and level differences. Signals from hearing implants do not fuse sufficiently, such as at the level of the brainstem. As a consequence of the inappropriate integration of the information ascending from the auditory nerves, no accurate (enough) binaural processing in the brain area is possible. Therefore, bilateral application of hearing implants results mainly in the ability to lateralize sounds and not in the ability to indicate the precise sound location. Consequently, sound localization in noisy backgrounds is also not optimal. Beam-formers in microphones for hearing implants are considered to be not accurate enough and processing is poor in terms of spatial and frequency resolution.

Some documents may be referred to. US 2021/096208 A1 recites an apparatus comprising at least one first microphone which is movably arranged, at least one second stationary microphone and at least one sensor is described. The microphones can capture the sound waves emitted by acoustic sources, and the sensor can capture spatial coordinates of the first microphone. A corresponding method and a system having the apparatus mentioned are also described. EP 2 449 795 A1 recites a method including: obtaining phase information dependent upon a time-varying phase difference between captured audio channels; obtaining sampling information relating to time-varying spatial sampling of the captured audio channels; and processing the phase information and the sampling information to determine audio control information for controlling spatial rendering of the captured audio channels. US 2020/236475 A1 recites a hearing aid is provided for use with a user having a first and second ears disposed on first and second body sides. The hearing aid apparatus is configured for enabling the user to hear sounds that originate from a plurality of directions and includes a first hearing aid member placeable on a user's first body side. The first hearing aid member includes a first transducer for receiving sounds that would be received by the user's first ear and converting those received sounds into first transmittable electrical signals. A second hearing aid member is placeable on the user's second body side and is preferably a cochlear implant device including an electrode array positionable within a cochlea of a user. The cochlear implant device includes a second transducer for receiving sounds that would be received by the user's second ear, and converting the sounds into second electrical signals; and also includes a receiver for receiving the first transmittable electrical signals, and a first signal processor for processing the second electrical signals and first transmittable electrical signals into signals configured for being received by the cochlea of user's second ear for facilitating the hearing of sounds that would be received by both of the user's first and second ears. Said prior art documents are considered to relate to relatively complex systems,

It is an object of the present invention to overcome one or more disadvantages of the microphones and hearing implants of the prior art and to provide alternatives to current implants, without jeopardizing functionality and advantages.

### SUMMARY OF THE INVENTION

In a first aspect the present invention relates to a biomimetic microphone, the biomimetic microphone comprising one or more audio receivers, wherein the one or more audio receivers is configured to sample sound in at least one sample series, that is wherein sound is in particular sampled into audio signals in a time sequence, wherein the sample series is a cyclic sample series, the sample series comprising at least two sound reception signals, and wherein the one or more audio receivers each individually are configured to receive spatial audio input in a spatially different audio receiver orientation, that is for instance a first orientation pointing along a z-axis, a second along a y-axis, or orientations in a plane (see below), or shifted orientations, such that the spatial inputs form a cyclic sample series, at least one processor comprising a computer program comprising instructions for processing audio input of the at least one audio receiver, and for providing audio output, wherein the processor is configured to select sound in at least one direction, and wherein processing audio input comprises forming a spectral transformation of said audio input into a frequency domain, the frequency domain representing the audio signal including magnitude (or amplitude) and phase for any given frequency, in said frequency domain selecting at least one dominant spectral component and typically all dominant spectral components and removing at least one non-dominant spectral components and typically all non-dominant spectral components, and forming a mathematical measured vector b thereof comprising magnitude and phase for at least one source frequency representing said audio input, typically a measured vector thereof as provided by the at least one audio receiver, wherein the at least one processor is further configured to receive at least one model matrix A, and configured to perform a regression on the at least one model matrix A and the mathematical measured vector b in order to solve equation Ax=b, wherein x is a vector comprising magnitude and phase for the at least one source frequency and at least one acoustic source position, and forming a spectrally adapted acoustic audio output signal of vector x by an inverse spectral transformation. The term “biomimetic” is used to express the resemblance (mimicry) of the present microphone with biological equivalents, in so far as relevant. The sample series is a time sequence of sound signals received, also referred to as sampled, by the one or more audio receivers, wherein, in the sequence, a sequence element (a first sample) is related to another sequence element (a second sample), such as by a change in time between said two sequence elements, by a change is position of the one or more audio receivers, and so on. In signal processing, sampling is used to indicate a reduction of a continuous-time signal to a discrete-time signal. A common example is the conversion of a sound wave to a sequence of “samples”. A sample is a value of the signal at a point in time and/or space. A sampler is a subsystem or operation that extracts samples from a continuous signal. The term “sequence” is used in its normal meaning, namely a series [of receptions] in which repetitions are allowed and order matters. The elements of the sequence are typically obtained with a separation in time between elements. As the at least one audio receiver is adapted to receive sound, in particular in a plane, the sequence is both spatially resolved and time resolved, either discrete or (semi)continuous. Such leaves open if one or more audio receivers are used; however they/it is configured to sample sound in at least one sample series, that is the end result so to speak is a sample series with the given characteristics thereof. Two basic embodiments of such one or more audio receivers are given, in the figures, in the claims, and in the description. Also, the term “cyclic” is used in its normal meaning [arranged in or belonging to a cycle], namely a series of related events or operations happening regularly and usually leading back to a starting point thereof, so beginning at some point in time or space, moving forward in time or space, and returning to the initial or first point in time or space. The term “orientation” is used to indicate a spatial direction to which a central axis of the at least one audio receiver is oriented, or likewise, in the direction it is moving, which orientation therefore may vary over time for a specific at least one audio receiver. Typically, a microphone's directionality or polar pattern indicates how sensitive it is to sounds arriving at different angles about its central axis, whereas in the present invention it is in particular used to identify the central axis only. The present processor and configuration of audio receivers does not require a static microphone, in fact one microphone would be sufficient, nor does it require a time-varying fractional delay filter in a time domain, nor a coherence estimation between a signal from a moving microphone and a static microphone; such a configuration only works when exactly one static microphone is present. which makes the present biomimetic microphone simpler, more robust, more accurate, and more versatile. In addition, the present at least one processor is configured to operate for a signal audio receiver, for two or more audio receivers, and in fact for a plurality of audio receivers, such as in an array of audio receivers, for an audio receiver moving in a plane, and combinations thereof. By providing the present one or more audio receivers a change in frequency of a wave in relation to said one or more receivers relative to at least one wave source is obtained. Therewith a relatively exact spatial location of said at least one wave source can be obtained. Also, a (nearly) perfect beam-former is obtained. Applicant has filed a patent application PCT/EP2022/068771, relating to a similar biomimetic microphone, which application and its contents are hereby incorporated by reference. In an example, the present biomimetic microphone, in combination with an implant, sends reliable and systematic information to the brain over one auditory nerve only. In the prior art technology in hearing implants microphones are static. The one or more audio receiver provides spatial localization of sound. The biomimetic microphone, as well as input provided thereto and output provided thereby, may be controlled in an analogue manner, or in a digital manner, or a combination thereof. At least one processor for processing audio input, and for providing output, is provided, which at least one processor may have further functionality. The at least one processor for processing audio input of the at least one audio receiver is in particular configured to select sound in at least one direction, and wherein processing audio input comprises forming a spectral transformation of said audio input, in said frequency domain selecting dominant spectral components and removing non-dominant spectral components, such as spectral components with the highest intensities, and/or in a specific frequency domain of interest, such as that of the human voice, and/or by resolving said spectral components, such as by selecting certain directions of sound source origins, such as in front of a user, and forming a mathematical measured vector thereof, and forming a spectrally adapted acoustic signal thereof by an inverse spectral transformation and optionally to process the input using at least one of Fourier transforming the audio input, inverse-Fourier transforming the transformed audio input, reducing white noise, filtering white noise, reducing background noise, filtering background noise, using a directional sensitive filter, using a bandpass filter, more in particular a filter with a bandwidth from 350 Hz-17 kHz, even more in particular a bandwidth from 900 Hz-6 kHz, and then providing output. Selecting sound in at least one direction indeed has the assumption that at least one sound source is being present, and possibly more than one, hence at least one. By resolving spatial inputs effectively also spatial positions of the at least one sound source are resolved, in particular by using model matrix A. The model matrix captures the Doppler shifts corresponding to the possible (but a priori unknown) spatial positions of the sound sources (see FIG. 10). And therefore it is possible to select sound in at least one direction, even without specific a priori knowledge thereof, e.g. by means of the regression (see FIG. 11) Also, in use, a power source, such as a battery, is typically present. The present biomimetic microphone can find application in for instance a cochlear implant, in auditory research, in a hearing aid, in sound processing, and for speech in noise. Measured vector b is further clarified. It is obtained from the audio input. Vector x clearly is not the model of the source(s), but rather the spectrally adapted acoustic audio output signal, to be resolved from measured vector b and model matrix A. The description is rather extensive in this respect, as are the figures FIG. 14 provides some further explanation of basics of the present invention. FIG. 14A represents three (1, 2 and 3) dominant frequencies ν [Hz], with given magnitude/amplitude A [Pa, or likewise sound pressure, and dB] as could be received by a single static microphone. Time sampling could be used. Slices indicated with s₁ and ₂ given as an example of sound sources being present at different spatial locations. When a moving microphone is used, such as a rotating microphone, or likewise a circular array of microphones being activated/de-activated in a cyclic circular sequence, broadening of the frequencies occur, typically due to the Doppler effect, as is shown in FIG. 14B (for each of frequencies 1, 2 and 3). The same is done for the phase φ in FIGS. 14C and 14D respectively. It is now a matter of finding the dominant spectral components in FIGS. 14B and 14D, and based on these dominant components, reconstructing the actual audio input signals. The present processor is configured to resolve spatial inputs form a cyclic sample series. As a result thereof for any and all audio sources, being at any spatial position, a regression can be performed, and actually is performed, with as a result, forming a spectrally adapted acoustic audio output signal of vector x by an inverse spectral transformation. Indeed the number of possible source locations as captured in the model matrix A can be different (and typically will be higher) than the actual (and typically unknown) number of acoustic sources as captured in the measurement vector b. Hence we use a regression to solve this potentially underdetermined system of equations for the vector x. As is well-known in the literature, a regression is able to do so by penalizing the coefficients in the system of equations that are not important or relevant for the resolving of the vector x. The specific way in which this is done depends on the type of regression (e.g. Ridge or Lasso). Such is considered inherent for the present microphone therefore.

In a second aspect the present invention relates to a product comprising at least one biomimetic microphone according to the invention, such as a single hearing implant, a hearing aid, a mobile device, such as a smartphone, a telecommunication device, a leak-detector, a sound detector, a movement detector, a sound location detector, and an audio product.

In a further aspect the present invention relates to a hearing implant comprising at least one biomimetic microphone according to the invention, being a single hearing implant for transmitting audio input to the brain over one auditory nerve, wherein the biomimetic microphone is adapted to provide output to at least one auditory nerve, such as by a cochlear implant, with the proviso that the hearing implant is adapted to provide output to the at least one auditory nerve at a left side of a human head or at a right side of the human head only. Surprisingly only one, hence a single hearing implant, can be used. The human brain is capable of making use of the output signal of the single hearing implant such that optimal speech in noise perception is more or less achieved. This is considered more effective than inappropriate integration of bilateral applied signals, which results in problems with understanding speech in noisy listening conditions (cocktail party phenomenon).

In yet a further aspect the present invention relates to a method of operating a hearing implant according to the invention, comprising activating the hearing implant, receiving spatial audio input with the at least one first audio receiver, processing audio input with the at least one processor, and providing output at one side of the head only to at least one auditory nerve, such as by a cochlear implant, to the brain over one auditory nerve.

The present invention also relates, in a further aspect, to a hearing implant computer program comprising instructions for operating the hearing implant according to the invention, the instructions causing the computer to carry out the following steps: activating the hearing implant, receiving spatial audio input with the at least one first audio receiver, processing audio input with the at least one processor, and providing output at one side of the head only to at least one auditory nerve, such as by a cochlear implant, to the brain over one auditory nerve.

Advantages of the present description are detailed throughout the description.

### DETAILED DESCRIPTION

It is noted that examples given, as well as embodiments are not considered to be limiting. The scope of the invention is defined by the claims.

In an exemplary embodiment of the present biomimetic microphone the at least one sample series is continuous or discrete.

In an exemplary embodiment of the present biomimetic microphone the one or more audio receivers is configured to receive sound in at least one plane, wherein the at least one plane is selected from a circle area, an ellipsoid area, a surface section of a sphere, such as a concave or convex section of a sphere, a surface section of a cone, or a surface section of a cylinder. It is noted that the plane can be curved, such as in the examples given.

In an exemplary embodiment of the present biomimetic microphone forming a spectral transformation of said audio input is by Fourier transforming (FT) the audio input into a frequency domain.

In an exemplary embodiment of the present biomimetic microphone the at least one processor is further configured to select spectral components of interest before forming the mathematical vector, in particular wherein spectral components are selected based on a source orientation [relative to a user] thereof, from a voice frequency band of 85-3000 Hz, in particular from 185-300 Hz, and harmonic frequencies thereof, and from high energy or high pressure frequencies.

In an exemplary embodiment of the present biomimetic microphone the at least one processor is further configured to receive at least one model matrix A, wherein the model matrix comprises a mathematical frequency domain model vector with model frequencies and energies of at least one acoustic source, and to perform a regression on the at least one model matrix A and the a mathematical measured vector b in order to solve equation Ax=b, wherein x is a vector comprising magnitude and phase for at least one source frequency and at least one acoustic source position, in particular a linear regression, in particular wherein the regression is selected from a Ridge regression, and a Lasso regression. For instance, in FIG. 6c-e and FIG. 7 such frequencies of the at least one source are shown. FIG. 8a,b could then be considered as a representation of vector x as a function of orientation, having a certain magnitude per direction. FIG. 6e could be considered as a graphical representation of matrix A, in particular of columns thereof, for a given source orientation. See also FIGS. 6, 12 and 13 in this respect.

In an exemplary embodiment of the present biomimetic microphone the at least one processor is further configured to perform for substantially all acoustic sources the regression.

In an exemplary embodiment of the present biomimetic microphone the at least one processor is configured to process audio input of substantially all audio receivers.

In an exemplary embodiment of the present biomimetic microphone the at least one processor is configured to process audio input of substantially all frequencies.

In an exemplary embodiment of the present biomimetic microphone the at least one processor is configured to process audio input of substantially all source positions.

In an exemplary embodiment of the present biomimetic microphone the at least one processor is configured to process audio input of substantially all sample series.

In an exemplary embodiment of the present biomimetic microphone the at least one processor is configured to identify side-bands, also referred to as side-branches, of said audio frequency, using said side-bands identifying a spatial reception direction of said frequency relative to said one or more audio receivers. A side-band may relate to a band of frequencies higher than or lower than a main or dominant frequency, that may be the result of a modulation process. An example of such a modulation process is the Doppler effect caused by changes in position of the audio receivers used to receive the sample series. The sidebands carry further information received with the audio input signal. The sidebands comprise further spectral components of the audio input signal. The signal components above the dominant frequency are typically considered to constitute the upper sideband (USB), and those below the dominant frequency to constitute the lower sideband (LSB). All forms of modulation produce sidebands.

In an exemplary embodiment of the present biomimetic microphone the at least one processor is configured to adapt the spectral transformation, wherein adapting is selected from at least one of reducing white noise, filtering white noise, reducing background noise, filtering background noise, using a directional sensitive filter, and using a bandpass filter, more in particular a filter with a bandwidth from 350 Hz-17 kHz, even more in particular a bandwidth from 900 Hz-6 kHz.

In an exemplary embodiment of the present biomimetic microphone the processor is configured to form at least one narrow band for the at least one audio frequency, the narrow band comprising a central audio frequency and a band of frequencies above and below said central audio frequency, in particular wherein said band is 0.1-5% relative of said central frequency wide. So, for at least one dominant frequency, a band, partly above and partly below said dominant frequency, is formed. This is a specific embodiment in which, in the step where the non-dominant spectral components are removed (e.g. as described in claim 1), only at least one dominant frequency and So for at least one dominant frequency a band.

In an exemplary embodiment the present biomimetic microphone comprises an actuator, in particular wherein said actuator is controlled by said at least one processor, wherein said actuator is configured to move said one or more audio receivers in said/an at least one plane, in particular wherein the actuator is a rotator, wherein the rotator is configured to rotate said one or more audio receivers in said at least one plane, in particular wherein the rotator is attached to a support, and wherein the one or more audio receivers is attached to said support, and wherein rotator is configured to rotate said support, or comprises an array of at least two audio receivers, and/or comprises a power source, such as a battery, and/or wherein the rotator is a stepper motor, and/or wherein the at least one processor is configured to control the rotator, and the one or more audio receivers, and/or wherein the at least one audio receiver is selected from an element adapted to rotate said one or more audio receivers eccentric of a rotating axis, from a static array of audio receivers located spaced apart from one and another, wherein by addressing individual audio receivers in the static array sound is received at spaced apart locations, wherein in the static array of audio receivers each audio receiver individually is adapted to be addressed by a receiver controller, and a combination thereof, and/or wherein the at least one audio receiver is adapted to operate in pulsating mode, and/or wherein the biomimetic microphone is adapted to sample sound in phase, to sample sound out of phase, to sample sound in a frequency dependent mode, or a combination thereof, and/or wherein the at least one audio receiver is in a reduced pressure environment, such as a sealed chamber, wherein the reduced pressure environment, each individually, in particular comprise a fluid-to-fluid sound transmitter, such as a membrane, and/or wherein the at least one direction in particular is pointing towards/from the biomimetic microphone, and/or wherein the processor is adapted to filter sound, such as sound in a frequency bandwidth, such as noise, and sound from at least one specific direction, and/or. wherein the at least one audio receiver each individually is adapted to receive sound in a frequency range of 100 Hz-20 kHz, and/or when comprises the static array of audio receivers located spaced apart from one and another, wherein the static array of audio receivers comprises 1 to n audio receivers, wherein audio receivers are located in a single or multiple curve, such as in circle, or in a spiral, such as an Archimedean spiral, a Fermat's spiral, a logarithmic spiral, a Fibonacci spiral, and a Theodorus spiral, or in a helix, in particular a spiral with 1-5 windings, such as with audio receivers at even or uneven distance from one and another, or a combination thereof, and/or wherein the static array of second audio receivers comprises 2-2¹⁰ audio receivers, in particular 3-2⁸ audio receivers, such as 4-2⁶ audio receivers, and/or wherein audio receivers each individually are selected from transducers, such as a Micro-Electro Mechanical System (MEMS), a moving coil, a permanent magnet transducer, a balanced armature transducer, and a piezo element. An array of audio receivers provides as advantage that a significant decrease in data is obtained, and data-compression is achieved, which may be relevant for certain time-data-limited-transfer applications, in particular wireless transfer of data from a hearing aid in one ear to a hearing aid in another ear, in order to preserve spatial information in the received signals.

In an exemplary embodiment of the present biomimetic microphone said at least one sample series is adaptable, and/or wherein said cyclic sample series has a sample series length of 1/1000-1 second, in particular 2/1000- 1/10 second, more in particular 5/1000- 1/20 second, such as 7/1000- 1/40 second. A microphone typically moves at a rotational speed of 10-10³ cm/sec, such as 50-250 cm/s. Likewise a series of microphones is addresses at a similar speed, wherein speed is then defined as a spacing between adjacent and addressed microphones divided by a (sample) time difference of adjacent microphones.

In an exemplary embodiment the present biomimetic microphone comprises a transceiver, in particular a wireless transceiver.

In an exemplary embodiment of the present biomimetic microphone said sample series is selected from a sample series with a constant cycle time, from a sample series with a decreasing cycle time, from a sample series with an increasing cycle time, and from combinations thereof. Such may be considered to relate to a sample series that may or not be constant over time, that is the same over time, or different over time. If it is different, the cycle time may be shorter, or larger, resulting in an decreased or increased cycle time. Such appears to be a matter of e.g. speeding up the rotations per minute of a microphone, or likewise the array of microphones.

In an exemplary embodiment the present biomimetic microphone further comprises at least one microphone posture sensor, in particular a sensor selected from a gyroscope, an accelerometer, an Inertial Measurement Unit (IMU) sensor, and combinations thereof, wherein the at least one processor is configured to process output of the at least one microphone posture sensor, wherein said audio input is enriched with said at least one microphone posture sensor output.

In an exemplary embodiment the present product is a single hearing implant for transmitting audio input to the brain over one auditory nerve, wherein the biomimetic microphone is adapted to provide output to at least one auditory nerve, such as by a cochlear implant, with the proviso that the hearing implant is adapted to provide output to the at least one auditory nerve at a left side of a human head or at a right side of the human head only.

In an exemplary embodiment of the present single hearing implant the hearing implant is adapted to transfer sound wireless from the biomimetic microphone to the cochlea.

In an exemplary embodiment of the present single hearing implant the hearing implant is fully implantable, or wherein the hearing implant comprises an external part, the external part comprises the biomimetic microphone, and in internal part, the internal part comprises at least one of a cochlear implant, and a vibrating implant.

In an exemplary embodiment the present single hearing implant comprises a housing, wherein the housing has a size of 1-5 cm by 1-5 cm and 0.2-2 cm.

In an exemplary embodiment the present single hearing implant comprises at least one coil for wireless transmission.

In an exemplary embodiment of the present single hearing implant the implant is adapted to provide a stimulus to the at least one audio nerve, in particular every 1-100 msec, such as every 10-20 msec.

In an exemplary embodiment the present single hearing implant comprises an electro-neuro interface for connecting the hearing implant to the at least one audio nerve, in particular comprises 1-24 electro-neuro interfaces, more in particular 9-12 electro-neuro interfaces.

In an exemplary embodiment of the present single hearing implant the electro-neuro interphase is adapted to be provided in the cochlea.

The invention is further detailed by the examples and accompanying figures, which are exemplary and explanatory of nature and are not limiting the scope of the invention. To the person skilled in the art, it may be clear that many variants, being obvious or not, may be conceivable falling within the scope of protection, defined by the present claims.

### SUMMARY OF THE FIGURES

FIGS. 1-4 show schematic layouts of exemplary biomimetic microphones.

FIG. 5 shows a schematic layout of reception of sound by a hearing implant including the present biomimetic microphone.

FIGS. 6a-e, 7, and 8a-b show examples.

FIGS. 9-11 show examples of signal processing.

FIGS. 12a,b, FIG. 13, and FIGS. 14A-D show examples of linear regression and processing.

### DETAILED DESCRIPTION OF THE FIGURES

In the figures:
1 biomimetic microphone
11 one or more audio receiver
12 one or more audio receiver
13 microphone arrangement
14 support
15 housing
20 processor
30 battery
40 actuator
50 hearing implant
60 cochlear implant

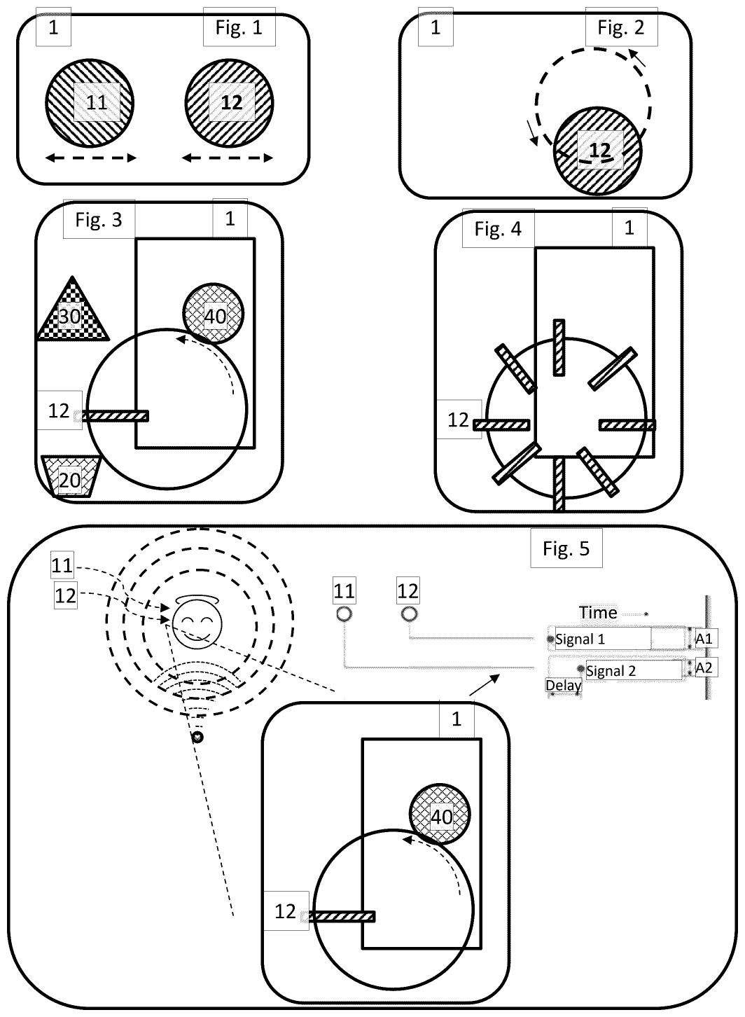

In FIG. 1 a biomimetic microphone 1 is shown, having a first audio receiver 11 and a second audio receiver 12. The first audio receiver 11 and second audio receiver 12 are adapted to move in a horizontal direction, back and forth, or likewise pulsate in said direction.

In FIG. 2 a biomimetic microphone 1 is shown, having an audio receiver 12. The audio receiver 12 is adapted to move in a circular direction, as indicated by the arrows.

In FIG. 3 a biomimetic microphone 1 is shown, having an audio receiver 12. The having an audio receiver 12 is adapted to move in a circular direction, as indicated by the arrows. In addition, schematically an actuator 40 for rotating a disc on which having an audio receiver 12 is located, a processor 20, and a battery 30 are indicated.

In FIG. 4 a biomimetic microphone 1 is shown, having one or more audio receivers 12, in this case 8. The audio receivers 12 are adapted to be addressed in a circular direction, for instance starting at the most left audio receiver first, followed by the lower left audio receiver, the lower middle audio receiver, the lower right audio receiver, etc. Any other order of addressing can be chosen.

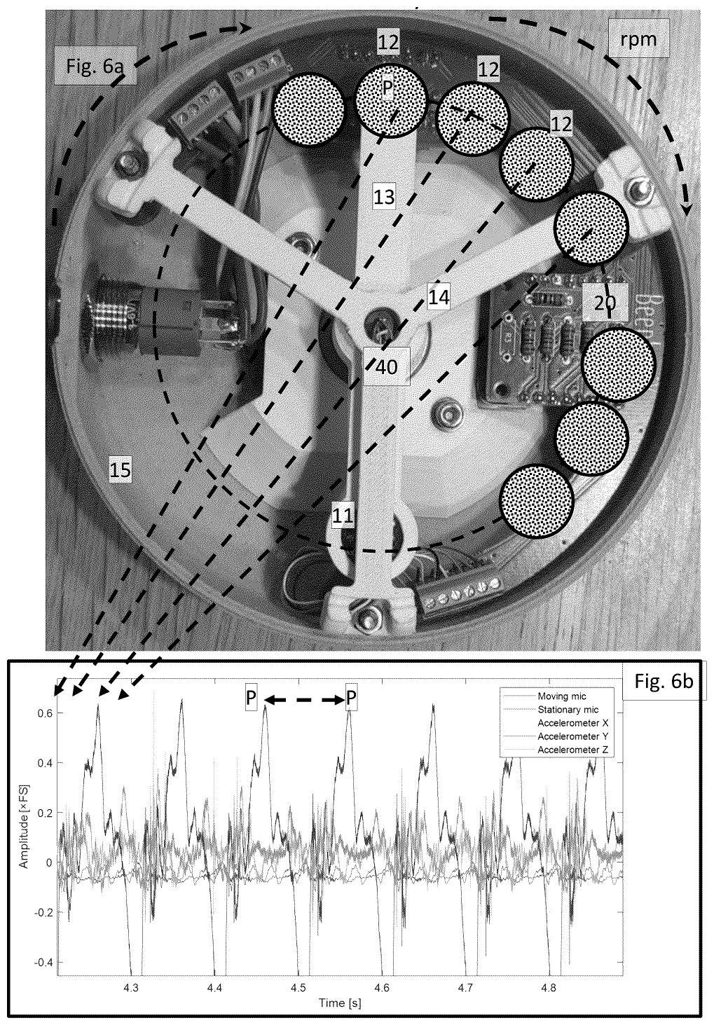

FIG. 5 shows a schematic layout of reception of sound by a hearing implant including the present biomimetic microphone. As microphone 12 moves towards and away from microphone 11 a dynamic time delay is created. Therefore, although the absolute distance between microphone 11 and microphone 12 is limited, a strong direction dependent cue is generated. Also, as signal 1 of microphone 12 may be different from a signal 2 of microphone 11, the two signals can easily be discriminated with this biomimetic microphone.

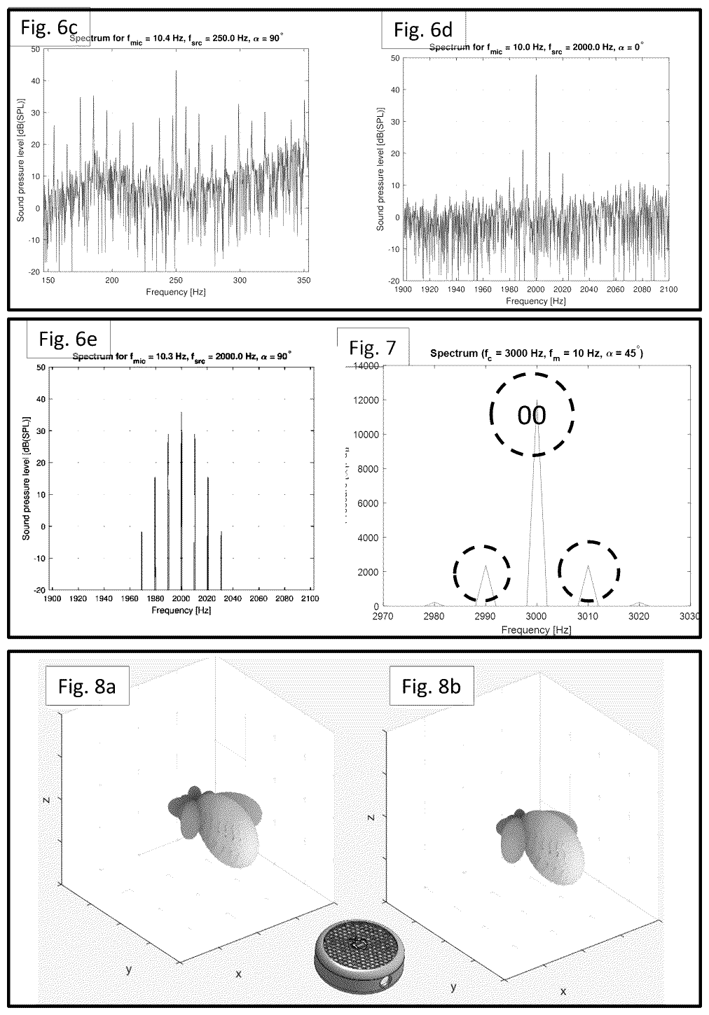

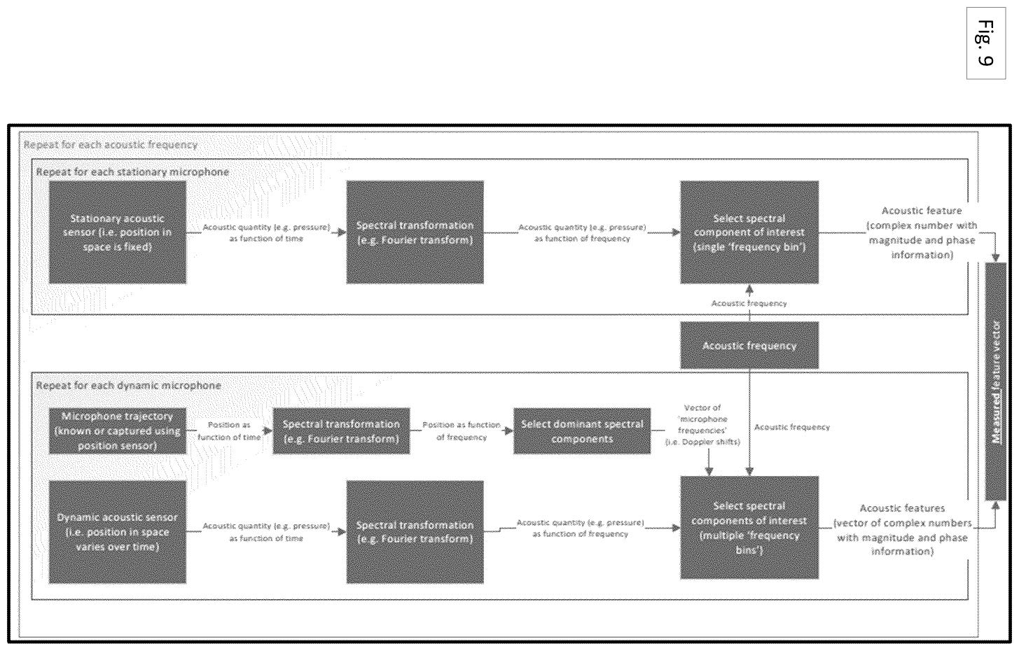

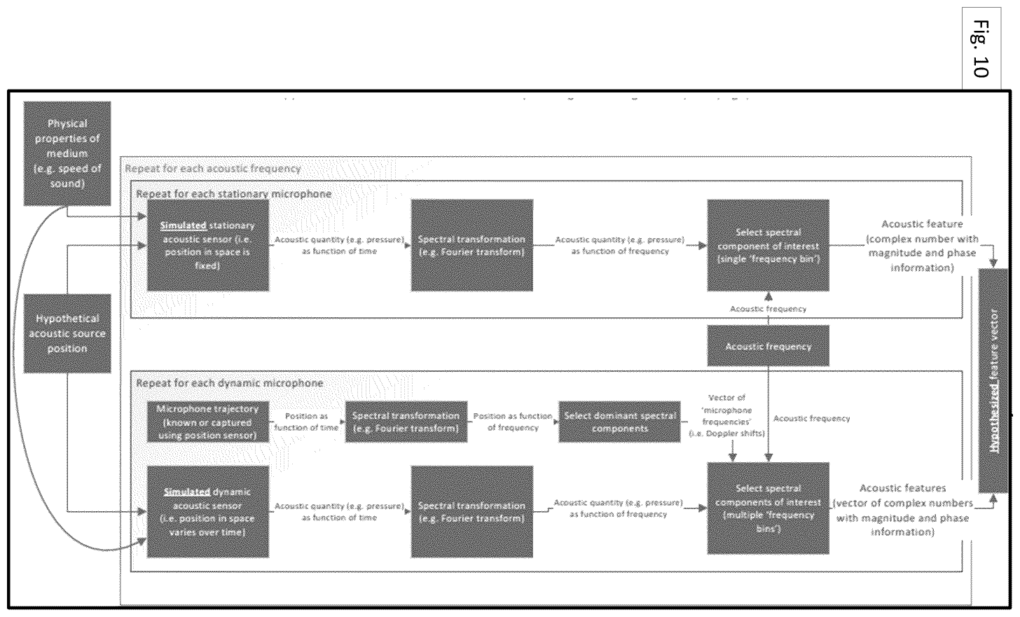

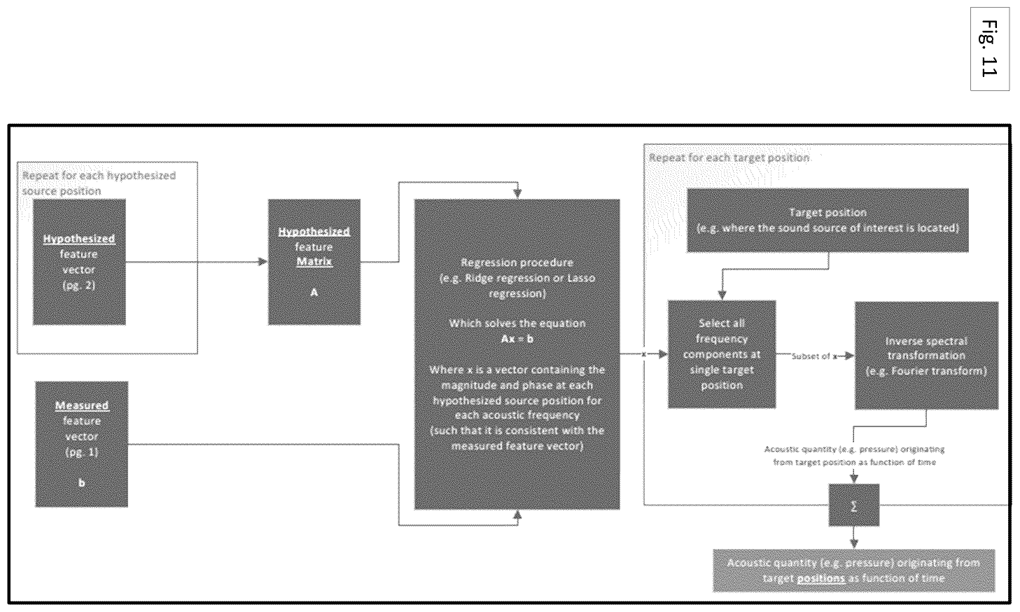

FIG. 6 shows a worked open example of the present biomimetic microphone, with a central rotator 40, one audio receiver 11 at a bottom end, and a processor 20. It is an example of the present biomimetic microphone device, comprising at least one microphone arrangement 13 typically mounted onto a support structure 14, which microphone arrangement comprises at least one microphone 11,12, wherein said microphone arrangement defines a plurality of different audio signal capturing or sampling positions, with may be defined with respect to the support structure, at least one processor, such as a microphone arrangement control unit programmed to control said at least one microphone to collect audio signals captured at a repetitive sample series of said different audio signal capturing positions, and wherein the at least one processor, such as an audio signal processing control unit, and optionally also a further processor, is programmed to process collected audio signals captured by said at least one microphone of said microphone arrangement, such that collected audio signals are subjected to a spectral transformation, typically in a predefined frequency domain, and are subjected to removal of non-dominant spectral components from dominant spectral components to calculate a mathematical vector, and to transform said mathematical vector into at least one spectrally adapted acoustic output signal by an inverse spectral transformation. The Beepod prototype demonstrates the working principle of our biomimetic dynamic microphone. It contains one dynamic audio receiver which moves in a circle at configurable speed (525 Hz), and one conventional static audio receiver. The Beepod is powered via USB-C and transmits its data over Bluetooth to a computer. The computer processes the data and visualizes the received sound as a function of direction of arrival (i.e. the measured beampattern). At this moment, a narrowband acoustic source, i.e. a sine wave signal, is used. Dimensions are 12 cm ø, 4 cm height, 78 mm azimuthal array aperture, 6 mm vertical array aperture. For the audio receivers 2×TDK InvenSense INMP441, High-precision 24 bit data (I2S interface), with a 61 dB(A) signal-to-noise ratio, a 120 dB(SPL) acoustic overload point, and a ±3 dB sensitivity matching, are used. For the motor 40 a Sanyo SS2421-5041, Bipolar pancake stepper motor, with operating conditions: 3.5 V/1.0 A, and a Trinamic TMC2209 ultra-silent motor driver is used. The microprocessor control unit 20 an Espressif ESP32-C3 processor, 160 MHz RISC-V microcontroller, with Wi-Fi and Bluetooth 5 (LE) radio, and a Low-power-mode support, is used. FIG. 6a shows sample positions of microphone 12, moving clockwise at a certain rations per minute or per second. At each discrete position (or continuously) sound is sampled, as is shown in FIG. 6b. In the example the at least one microphone moves in a circle in a circle area from a starting position P, clockwise cycling back to position P. As in the example a source with a constant frequency is use, such is reflected in the sampled sound. FIG. 6b also shows input obtained from the at least one microphone posture sensor, in particular from accelerometers X, Y, and Z, respectively. The information with respect to the stationary mic is for comparison mainly. FIG. 6c shows a spectral transfer (typically a Fourier Transform) of a more broadband sample into the frequency domain when incoming sound is at an angle of 90 degrees, and FIG. 6d for an angle of 0 degrees. What can be understood is if sound comes in under an angle more side bands are created, reflecting the orientation of sound with respect to the at least one microphone. Clearly, if a microphone rotates, as in the example, the angle of incoming sound may change during rotation. After spectral transformation of the audio input, a number of peaks or spectral components is visible, reflecting the dominant frequencies. The present processor is configured to select spectral components of interest, which is schematically indicated in FIG. 7 with the dashed circles. Other spectral components are neglected. Such is further detailed in FIG. 6e, wherein, after selecting dominant spectral components and removing non-dominant spectral components, a mathematical vector thereof is formed, represented by a limited number of frequencies in this example. The mathematical model may be calculated by the present at least one processor, or may be provided by an external processor. FIG. 6e may be considered to represent model matrix A, and FIG. 6d measured vector b. After linear regression, identifying component x of the mathematical equation Ax=b, an inverse spectral transformation is performed. Finally the microphone arrives in its initial position, in this case a top position, completing a cycle, and sampling may start all over again, in a subsequent cycle, or part thereof. The dominant spectral components, as are also shown in FIG. 7, may reflect a specific direction, and obviously a dominant frequency therein, such as a human voice, that is in a specific frequency domain or frequency band width.

FIG. 7. Example of the frequency spectrum of a signal captured by the moving microphone.

FIG. 8a,b show a beampattern for an acoustic source playing a 2.5 kHz sinusoidal wave located along a negative y-axis with a 4 Hz audio receiver rotation speed. Left using both a dynamic, rotating, audio receiver, and a static, fixed audio receiver at a spacing from said dynamic audio receiver, and right, using only the dynamic audio receiver. No significant difference is observed, showing that a dynamic audio receiver only suffices for the present microphone.

FIGS. 9-11 show examples of signal processing.

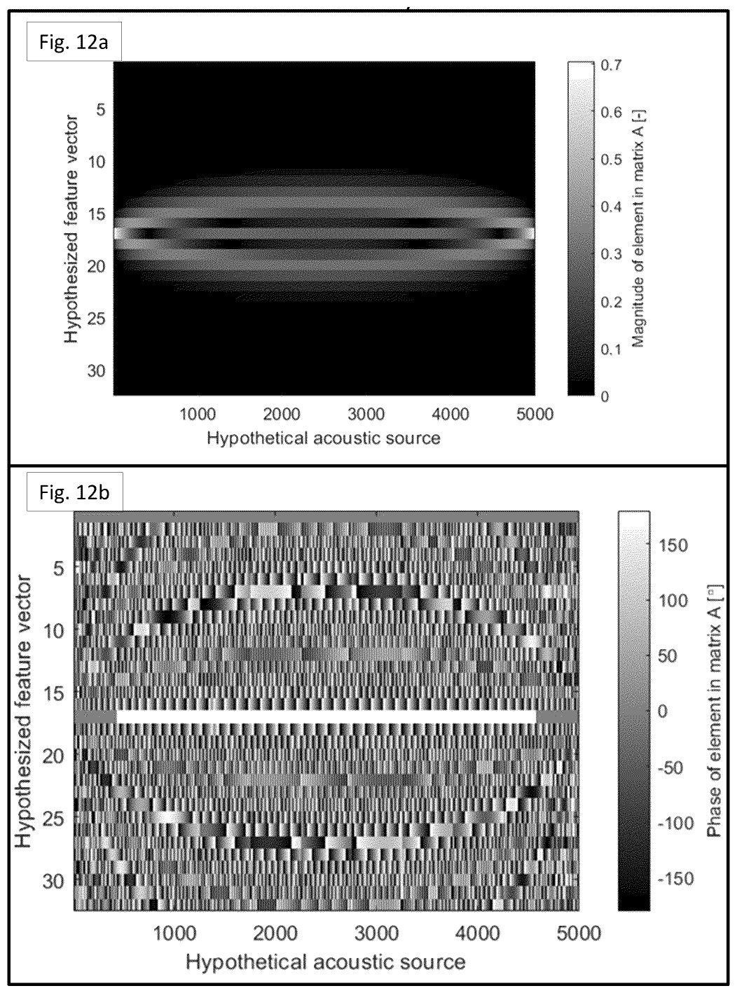

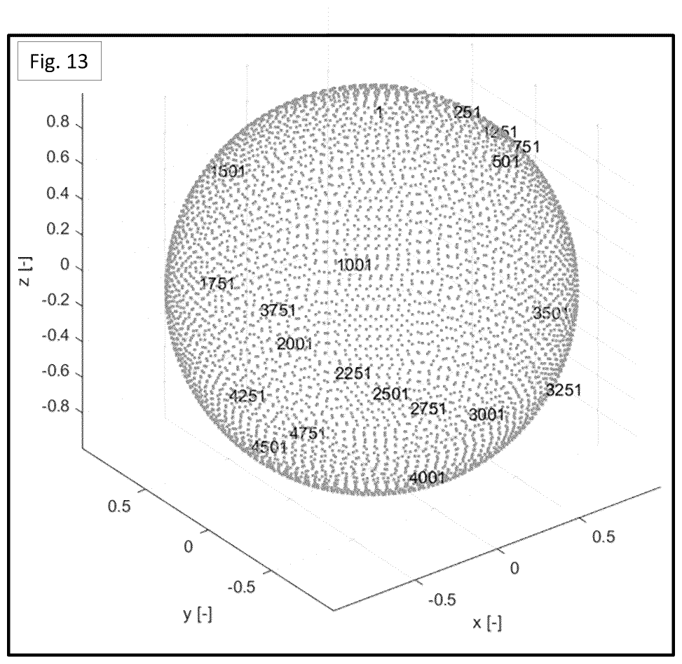

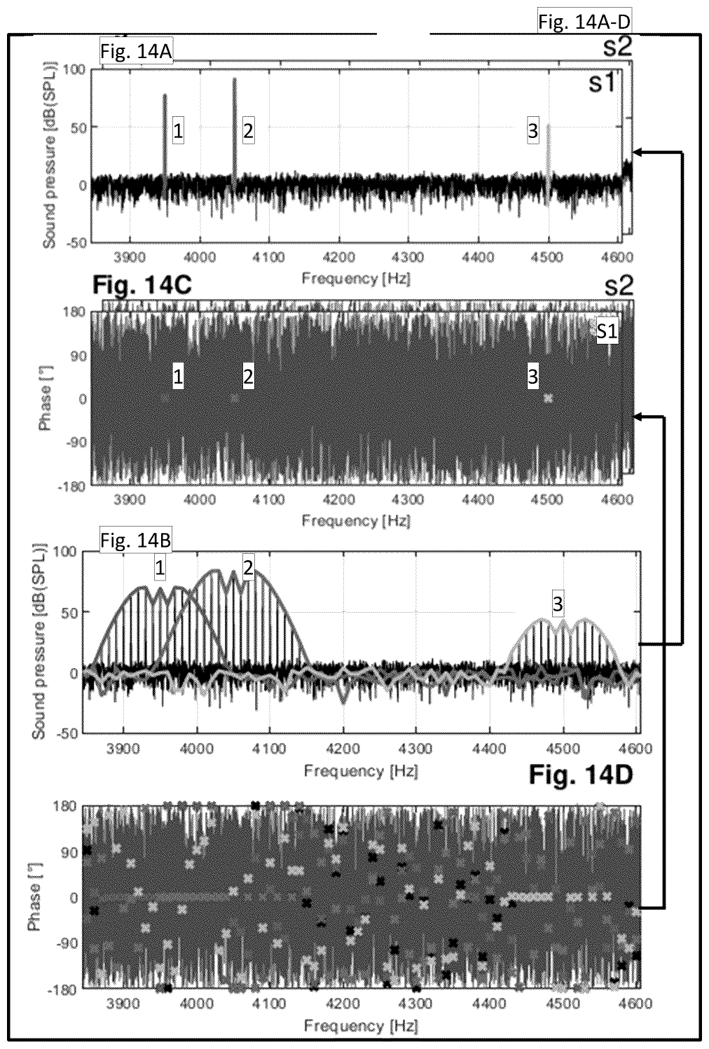

FIG. 12 shows an example of a set of hypothetical acoustical sources, which may be provided beforehand, a hypothesized feature vector, and the magnitude (FIG. 12a) and the phase (FIG. 12b) of the given elements in the corresponding matrix A, as provided by the at least one processor. This is for a source frequency of 6 kHz and a microphone frequency of 10 Hz for a configuration of microphones as placed for example in the Beepod prototype (FIG. 6a).

FIG. 13 shows a relation plot between hypothetical acoustic sources and their positions. This shows how for instance 5000 columns of the matrix A above correspond to 5000 hypothetical source locations. For some points, the number of the corresponding column is included in the figure (not for all of them because then it would become unreadable).

### Example

### Sound Model

A signal from the source as it would be measured at the origin is defined as:

$$s ( t ) {A}_{c} cos ( 2 π {f}_{c} t + {ϕ}_{c} ) [ Pa ] .$$

This can be generalized for an arbitrary position x:

$$s ( t , x ) = {A}_{c} cos ( 2 π {f}_{c} t + {ϕ}_{c} - k \cdot x ) [ Pa ] .$$

where k·x is the inner product between the wavevector and the position of the observer. The horizontal position of the micro hone is defined as:

$$m ( t ) {A}_{m} cos ( 2 π {f}_{m} t + {ϕ}_{m} ) [ m ] ,$$

and the vertical position is ways zero. This means that the received signal becomes:

$$r ( t ) = {A}_{c} cos ( 2 π {f}_{c} t + {ϕ}_{c} - {k}_{x} \cdot m ( t ) ) [ Pa ] .$$

At this point, we define the phase modulation index as β [symbol] kₓAₘ≙2πAₘ/λ sin(α). The larger the phase modulation index, the stronger the received signal is affected by the movement of the microphone. The modulation index depends on two important factors:
The ratio of the microphone deflection and the acoustic wavelength.
The angle of incidence.

The phase modulation index directly determines the frequency contents in the received signal, i.e. the observed acoustic frequencies (which are shifted from the actual acoustic frequency).

For the case φₘ=−π/2 and φ_{c}=0, r(t) can be expressed as the following Fourier series:

$$r ( t ) = {A}_{σ} {{\sum }^{∞}}_{n = ∞} {J}_{n} ( β ) cos ( 2 π ( {f}_{c} - {nf}_{m} ) t ) ,$$

where Jₙ is a standard function known as the Bessel function of the first kind of the nth order.

### Accelerometer Selection

To capture the phase φₘ (i.e. position) and frequency fₘ of the moving microphone, and account for any deviations from the ideal sinusoidal motion, we have mounted an accelerometer close to the moving microphone. In particular, inventors have selected the Analog Devices ADXL317, because it has a convenient I2S output that can be connected to the same USB to I2S interface as the microphones. This way, it is captured synchronously with the microphone signals.

### Equipment

Inventors have performed the measurements in a soundproof room. While not a true anechoic chamber, the walls and ceiling were covered in a perforated absorptive material. Extra foam blocks were placed in the corners of the room and behind the prototype to further reduce reflections. The prototype was mounted on a heavy anti-vibration table (approx. 50 cm height) and the acoustic source was placed at 1 meter distance at varying angles. Inventors used a Genelec 8000 series speaker, connected via a Motu UltraLite AVB digital-to-analog converter to the MiniDSP USBStreamer USB-to-I2S interface via TOSLink. In this way, the computer can use a single sound card both for recording and playback of the test stimuli (sine waves of 250, 500, 1000, 2000, 4000, 8000 Hz), preventing issues with multiple sound cards competing for USB bandwidth. The sample frequency was 48 kHz. The length of the measurements was 11 seconds, and the source signal was started 3 seconds before the measurements to ensure it has reached steady state. Finally, we used a SwitchBot Meter CB to log the temperature (22.8 C) and relative humidity (34%) to obtain a corresponding sound speed of 344.16 m/s.

Inventors found that an amount and magnitude of sidebands around the acoustic frequency increases as the acoustic frequency increases. This matches with expectations, since the phase modulation index (from our theoretical analysis) is inversely proportional to the acoustic wavelength. It is also a well-known fact in traditional array beamforming that, for a fixed array size, the resolution (narrowness of the beam) increases with frequency (i.e. beamforming is more difficult for low frequencies). This fact is captured by the Rayleigh diffraction limit. From this data, the achievable beam width cannot be directly estimated. However, the Rayleigh diffraction limit was originally derived for an optic lens (i.e. a ‘continuous microphone disk’), suggesting that it might still apply to a moving microphone. For the frequencies of 250 Hz and 500 Hz, many peaks are visible at multiples of the deflection frequency (n×10.4 and n×10.3 Hz, respectively). These are caused by vibrations of the motion system and are not related to the sidebands due to the Doppler effect (which are at 250 Hz±n×10.4 Hz and 500 Hz±n×10.3 Hz).

As the direction of arrival aligns more with the axis of maximum deflection (Y), the number and magnitude of the sidebands increases. The difference is largest for the first few steps; above α=60 degrees, the spectra look very similar to each other. This matches with our expectations, since the phase modulation index is proportional to sin(a).

### Signal Processing

Feature Extraction from Measurement Signals (FIG. 9)

Each stationary sensor results in a single acoustic feature per acoustic frequency. However, each dynamic acoustic sensor results in a vector of acoustic features per acoustic frequency. The larger the movement of the microphone compared to the acoustic wavelength, the larger this vector will be.

The procedure can be repeated for multiple acoustic frequencies to construct a broadband algorithm (filter bank approach). The caveat is that the acoustic features for the dynamic acoustic sensor might not be orthogonal as a function of acoustic frequency since their spectral components of interest might overlap due to the Doppler shifts. This is taken into account by the regression algorithm.

### Feature Synthesis (FIG. 10)

Each stationary sensor results in a single acoustic feature per acoustic frequency. However, each dynamic acoustic sensor results in a vector of acoustic features per acoustic frequency. (The larger the movement of the microphone compared to the acoustic wavelength, the larger this vector will be.)

The procedure can be repeated for multiple acoustic frequencies to construct a broadband algorithm (filter bank approach). The caveat is that the acoustic features for the dynamic acoustic sensor might not be orthogonal as a function of acoustic frequency since their spectral components of interest might overlap due to the Doppler shifts. This is taken into account by the regression algorithm.

### Regression Procedure (FIG. 11)

The measured feature vector is mapped to the hypothesized feature vectors using a linear regression procedure. After the regression, the components corresponding to the target positions (i.e. where the sound sources of interest are located) are extracted, converted to a time signal and summed together to produce the filtered audio stream focusing on just the sound sources of interest.

1. A biomimetic microphone, the biomimetic microphone comprising
at least one audio receivers, wherein the at least one audio receivers is configured to sample sound in at least one sample series, wherein the sample series providing an audio input, is a cyclic sample series, the sample series comprising at least two sound reception sample signals, wherein the at least one sample series is selected from continuous and discrete,
and wherein the at least one audio receivers each individually are configured to receive samples of the sample series of spatial audio input wherein each sample is received in a selection from a spatially different audio receiver orientation and audio receiver position, such that the spatial inputs form the cyclic sample series, and
at least one processor for processing audio input of the at least one audio receiver, and for providing audio output, wherein the processor is configured to select sound in at least one direction, and wherein processing audio input and selected sound in at least one direction comprises forming a spectral trans-formation of said audio input into a frequency domain, in said frequency domain selecting dominant spectral components and removing non-dominant spectral components and forming a mathematical measured vector b thereof comprising magnitude and phase of at least one of the dominant spectral components for at least one source frequency representing said audio input, wherein the at least one processor is further configured to receive at least one model matrix A, and configured to perform a regression on the at least one model matrix A and the mathematical measured vector b in order to solve equation Ax=b, wherein x is a vector comprising magnitude and phase for the at least one source frequency and at least one acoustic source position, and forming a spectrally adapted acoustic audio output signal of vector x by an inverse spectral transformation.

2. (canceled)

3. The biomimetic microphone according to claim 1, wherein the at least one audio receivers is configured to receive sound in at least one plane, wherein the at least one plane is selected from a circle area, an ellipsoid area, a surface section of a sphere, such as a selection of concave and convex section of a sphere, a surface section of a cone, and a surface section of a cylinder.

4. The biomimetic microphone according to claim 1, wherein forming a spectral transformation of said audio input is by Fourier transforming (FT) the audio input into a frequency domain.

5. The biomimetic microphone according to claim 1, wherein the at least one processor is further configured to select spectral components of interest before forming the mathematical vector, wherein spectral components are selected based on a source orientation relative to a user thereof, from a voice frequency band of 85-3000 Hz, and harmonic frequencies thereof, and from a selection of high energy and high pressure frequencies.

6. The biomimetic microphone according to claim 1, wherein the model matrix A comprises a mathematical frequency domain model vector with model frequencies and energies of at least one acoustic source, and wherein the regression is a linear regression, wherein the regression is selected from a Ridge regression, and a Lasso regression wherein the at least one processor is further configured to perform for substantially all dominant spectral components of the acoustic sources the regression.

7. (canceled)

8. The biomimetic microphone according to claim 1, wherein the at least one processor is configured to process a selection of audio input of substantially all audio receivers,
wherein the at least one processor is configured to process audio input of substantially all frequencies, and
wherein the at least one processor is configured to process audio input of substantially all source positions, and
wherein the at least one processor is configured to process audio input of substantially all sample series.

9-11. (canceled)

12. The biomimetic microphone according to claim 1, wherein the at least one processor is configured to identify side-bands of said audio frequency, using said side-bands identifying a spatial reception direction of said frequency relative to said at least one audio receivers.

13. The biomimetic microphone according to claim 1, wherein the at least one processor is configured to adapt the spectral transformation, wherein adapting is selected from at least one of reducing white noise, filtering white noise, reducing background noise, filtering background noise, using a directional sensitive filter, and using a bandpass filter, wherein the bandpass filter is a filter with a bandwidth from 350 Hz-17 kHz.

14. The biomimetic microphone according to claim 1, wherein the processor is configured to form at least one narrow band for the at least one audio frequency, the narrow band comprising a central audio frequency and a band of frequencies above and below said central audio frequency, wherein said band is 0.1-5% relative of said central frequency wide.

15. The biomimetic microphone according to claim 1, comprises a selection of an actuator, wherein said actuator is controlled by said at least one processor, wherein said actuator is configured to move said at least one audio receivers in said/an at least one plane, wherein the actuator is a rotator, wherein the rotator is configured to rotate said at least one audio receivers in said at least one plane, wherein the rotator is attached to a support, and wherein the at least one audio receivers is attached to said support, and wherein rotator is selected from rotator configured to rotate said support, and
an array of at least two audio receivers, and
comprising a power source, such as a battery, and
wherein the rotator is a stepper motor, and
wherein the at least one processor is configured to control the rotator, and the at least one audio receivers, and
wherein the at least one audio receiver is selected from an element adapted to rotate said at least one audio receivers eccentric of a rotating axis, from a static array of audio receivers located spaced apart from one and another, wherein by addressing individual audio receivers in the static array sound is received at spaced apart locations, wherein in the static array of audio receivers each audio receiver individually is adapted to be addressed by a receiver controller, and a combination thereof, and
wherein the at least one audio receiver is adapted to operate in pulsating mode, and
wherein the biomimetic microphone is adapted to a selection of sample sound in phase, to sample sound out of phase, to sample sound in a frequency dependent mode, and a combination thereof, and wherein the at least one audio receiver is in a reduced pressure environment, such as a sealed chamber,
wherein the reduced pressure environment, each individually, comprise a fluid-to-fluid sound transmitter, such as a membrane, and
wherein the at least one direction is pointing towards/from the biomimetic microphone, and
wherein the processor is adapted to filter sound, such as sound in a frequency bandwidth, such as noise, and sound from at least one specific direction, and.
wherein the at least one audio receiver each individually is adapted to receive sound in a frequency range of 100 Hz-20 kHz, and.
when comprising the static array of audio receivers located spaced apart from one and another, wherein the static array of audio receivers comprises 1 to n audio receivers, wherein audio receivers are located in a selection of single and multiple curve, such as selected from in circle, and in a spiral, such as an Archimedean spiral, a Fermat's spiral, a logarithmic spiral, a Fibonacci spiral, and a Theodorus spiral, and in a helix, a spiral with 1-5 windings, such as with audio receivers selected from at even and uneven distance from one and another, and a combination thereof, and
wherein the static array of second audio receivers comprises 2-210 audio receivers, and
wherein audio receivers each individually are selected from transducers, such as a MEMS, a moving coil, a permanent magnet transducer, a balanced armature transducer, and a piezo-element.

16. The biomimetic microphone according to claim 1, wherein said at least one sample series is selected from adaptable, and wherein said cyclic sample series has a sample series length of 1/1000-1 second, wherein said sample series is selected from a sample series with a constant cycle time, from a sample series with a decreasing cycle time, from a sample series with an increasing cycle time, and from combinations thereof.

17. The biomimetic microphone according to claim 1, comprising a transceiver, a wireless transceiver.

18. (canceled)

19. The biomimetic microphone according to claim 1, further comprising at least one microphone posture sensor, a sensor selected from a gyroscope, an accelerometer, an Inertial Measurement Unit (IMU) sensor, and combinations thereof, wherein the at least one processor is configured to process output of the at least one microphone posture sensor, wherein said audio input at least one microphone posture sensor output is provided to said audio input which is therewith enriched.

20. A product comprising at least one biomimetic microphone according to claim 1, such as a single hearing implant, a hearing aid, a mobile device, such as a smartphone, a telecommunication device, a leak-detector, a sound detector, a movement detector, a sound location detector, and an audio product wherein the product is a single hearing implant for transmitting audio input to the brain over one auditory nerve,
wherein the biomimetic microphone is adapted to provide output to as least one auditory nerve, such as by a cochlear implant,
with the proviso that the hearing implant is adapted to provide output to the at least one auditory nerve at a selection of a left side of a human head and at a right side of the human head only,
wherein the hearing implant is adapted to transfer sound wireless from the biomimetic microphone to the cochlea.

21-22. (canceled)

23. The hearing implant according to claim 14, wherein the hearing implant is selected from fully implantable, and wherein the hearing implant comprises an external part, the external part comprising the biomimetic microphone, and in internal part, the internal part comprising at least one of a cochlear implant, and a vibrating implant.

24. The hearing implant according to claim 14, comprising a housing, wherein the housing has a size of 1-5 cm by 1-5 cm and 0.2-2 cm, and comprising at least one coil for wireless transmission.

25. (canceled)

26. The hearing implant according to claim 14, wherein the implant is adapted to provide a stimulus to the at least one audio nerve every 1-100 msec.

27. The hearing implant according to claim 14, comprising an electro-neuro interface for connecting the hearing implant to the at least one audio nerve, comprising 1-24 electro-neuro interfaces,
wherein the electro-neuro interphase is adapted to be provided in the cochlea.

28. (canceled)

29. Method of operating a hearing implant according to claim 14, comprising
activating the hearing implant,
receiving spatial audio input with the at least one first audio receiver,
processing audio input with the at least one processor, and providing output at one side of the head only to at least one auditory nerve, such as by a cochlear implant, to the brain over one auditory nerve.

30. A hearing implant computer program comprising instructions for operating the hearing implant according to claim 14, the instructions causing the computer to carry out the following steps:
activating the hearing implant,
receiving spatial audio input with the at least one first audio receiver,
processing audio input with the at least one processor, and providing output at one side of the head only to at least one auditory nerve, such as by a cochlear implant, to the brain over one auditory nerve.
